(19) United States
(12) Patent Application Publication
(10) Pub. No.: US 2019/0263097 A1
(43) Pub. Date: Aug. 29, 2019

(54) GRAPHENE COMPOSITE FILM AND MANUFACTURING METHOD THEREOF

(71) Applicant: Chien Hwa Coating Technology , Inc., Hsinchu (TW)

(72) Inventors: Chun-Chen CHEN, Hsinchu (TW); Chien-Hua HUANG, Hsinchu (TW)

(21) Appl. No.: 16/285,238

(22) Filed: Feb. 26, 2019

(30) Foreign Application Priority Data
Feb. 26, 2018 (TW) 107106410

(51) Int. Cl. B32B 27/20; B32B 27/08; B32B 27/36; B29C 48/00; B29C 48/21; B29C 48/154; B29C 55/00; B29C 55/16; C01B 32/184; C01B 32/194; C08K 3/04; C08G 63/183; C08J 3/205

(52) U.S. Cl. CPC B32B 27/20; B29K 2067/003; B32B 27/36; B29C 48/022; B29C 48/0018; B29C 48/21; B29C 48/154; B29C 55/005; B29C 55/16; C01B 32/184; C01B 32/194; C08K 3/042; C08G 63/183; C08J 3/2053; B32B 2307/518; B32B 27/08

(57) ABSTRACT

The present invention provides a method of manufacturing a graphene composite film. The method includes the following steps: dispersing graphene in a polyester polymer or a cross-linked polymer to form a mixture; preparing a composite layer including a layer having the mixture and a layer having polyester; and stretching the composite layer biaxially to form the graphene composite film. A graphene composite film is disclosed as well.

### CROSS-REFERENCE TO RELATED APPLICATION

This application claims priority to Taiwan Application Serial Number 107106410, filed Feb. 26, 2018, which is herein incorporated by reference.

### BACKGROUND

### Field of Invention

The present invention relates to a graphene composite film and manufacturing method thereof

### Description of Related Art

Graphene has a hexagonal planar structure which is composed of carbon atoms arranged in sp² orbital hybridization. Graphene is widely used in many fields due to its high electrical conductivity, high thermal conductivity and stable lattice structure. Graphene is also suitable for forming graphene composite materials.

However, when graphene is fabricated into a graphene composite material, the conductivity of the resulting graphene composite material will be significantly reduced. Besides, the high cost of graphene brings some drawbacks to the mass production of graphene. Moreover, in practice, the thickness of the graphene composite material is as thin as possible. Therefore, there is a need for a graphene composite film having a high conductivity, a low cost, and a small thickness. In addition, a method for manufacturing a high conductivity, low cost, and small thickness graphene composite film is also required.

### SUMMARY

One aspect of the present invention is to provide a manufacturing method of graphene composite film. The manufacturing method includes operations of: dispersing graphene and diester in diol and adding dicarboxylic acid thereto form a liquid dispersion; subjecting the liquid dispersion in an environment at a temperature of 180° C. to 300° C. to form a polyester polymer by a polymerization of the diol, the diester and the dicarboxylic acid, in which the graphene is dispersed in the polyester polymer to form a graphene-polyester polymer mixture; co-extruding the graphene-polyester polymer mixture and a polyester material to form a composite layer, in which the composite layer includes a first graphene-polyester mixture layer and a polyester layer; and biaxially stretching the composite layer to form the graphene composite film.

In one embodiment, before the operation of dispersing the graphene and the diester in the diol, the manufacturing method further includes a pretreatment process for forming the graphene. The pretreatment process includes: heating a mixture of a spherical graphite and alkali metal to form a graphite intercalation compound, in which the alkali metal is intercalated between structural layers of the spherical graphite; mixing the graphite intercalation compound with an aromatic nitrile compound, in which the graphite intercalation compound reacts with the aromatic nitrile compound to form the graphene.

In one embodiment, the diol includes at least one of ethylene glycol, 1,3-propanediol, and 1,4-butanediol.

In one embodiment, the diester includes sodium ethylene glycol isophthalate-5-sulfonate:

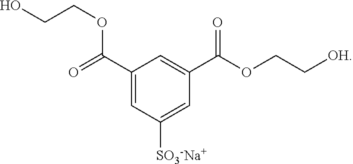

In one embodiment, the dicarboxylic acid includes terephthalic acid.

In one embodiment, the graphene has a weight percentage ranges from 0.1 wt % to 10 wt %, based on the total weight of the graphene-polyester polymer mixture.

In one embodiment, the polyester material includes polyethylene terephthalate (PET).

In one embodiment, a thickness ratio of the first graphene-polyester mixture layer to the polyester layer ranges from 1:19 to 1:2.

In one embodiment, the composite layer further includes a second graphene-polyester polymer mixture layer, and the polyester layer is between the first graphene-polyester mixture layer and the second graphene-polyester polymer mixture layer.

In one embodiment, the second graphene-polyester polymer mixture layer and the first graphene-polyester mixture layer have a same material composition.

In one embodiment, a thickness ratio of the second graphene-polyester polymer mixture layer to the polyester layer ranges from 1:19 to 1:2.

In one embodiment, the operation of biaxially stretching the composite layer includes stretching the composite layer simultaneously along a first direction and a second direction that is perpendicular to the first direction.

In one embodiment, the operation of biaxially stretching the composite layer includes stretching the composite layer along a first direction and sequentially stretching the composite layer along a second direction that is perpendicular to the first direction.

In one embodiment, a stretching ratio of the biaxially stretching ranges from 2 to 5.

Another aspect of the present invention is to provide a graphene composite film having a first graphene-polyester and a polyester layer. The first graphene-polyester mixture layer includes a plurality of graphene particles and polyester, and the graphene particles are dispersed in the polyester. The polyester layer is in contact with the first graphene-polyester mixture layer.

In one embodiment, the graphene particles have a weight percentage of 0.1 wt % to 10 wt % in the first graphene-polyester mixture layer.

In one embodiment, the polyester layer includes polyethylene terephthalate (PET).

In one embodiment, a thickness ratio of the first graphene-polyester mixture layer to the polyester layer ranges from 1:19 to 1:2.

In one embodiment, the graphene composite film further includes a second graphene-polyester polymer mixture layer. The polyester layer is between the first graphene-polyester mixture layer and the second graphene-polyester polymer mixture layer. The first graphene-polyester mixture layer and the second graphene-polyester polymer mixture layer have a same material composition.

In one embodiment, a thickness ratio of the second graphene-polyester polymer mixture layer and the polyester layer ranges from 1:19 to 1:2.

In yet another aspect of the invention is to provide a manufacturing method of graphene composite film. The manufacturing method includes operations of: dispersing graphene powder in a dispersant to form a liquid dispersion; adding poly(vinyl alcohol) and borate into the liquid dispersion, such that poly(vinyl alcohol) undergoes a crosslinking reaction to form a crosslinked poly(vinyl alcohol) and the graphene powder is dispersed in the crosslinked poly(vinyl alcohol), thereby forming a crosslinked poly(vinyl alcohol)-graphene mixture; coating the crosslinked poly(vinyl alcohol)-graphene mixture on a polyester substrate to form a composite layer, in which the composite layer includes a crosslinked poly(vinyl alcohol)-graphene mixture layer and the polyester substrate; and biaxially stretching the composite layer to form a graphene composite film.

In one embodiment, the manufacturing method further includes performing a pretreatment process to form the graphene powder before the operation of dispersing the graphene powder in the dispersant to form the liquid dispersion. The pretreatment process includes: heating a mixture of a spherical graphite and alkali metal to form a graphite intercalation compound, in which the alkali metal is intercalated between structural layers of the spherical graphite; mixing the graphite intercalation compound with an aromatic nitrile compound, in which the graphite intercalation compound reacts with the aromatic nitrile compound to form the graphene.

In one embodiment, the dispersant is selected from the group consisting of isopropanol, N-Methyl-2-Pyrrolidone (NMP), water, and a combination thereof.

In one embodiment, the borate includes sodium tetraborate.

In one embodiment, the graphene powder has a weight percentage ranged from 0.1 wt % to 25 wt % in the crosslinked poly(vinyl alcohol)-graphene mixture.

In one embodiment, the polyester substrate includes polyethylene terephthalate (PET).

In one embodiment, a thickness ratio of the crosslinked poly(vinyl alcohol)-graphene mixture layer to the polyester substrate ranges from 1:19 to 1:2.

In one embodiment, the operation of biaxially stretching the composite layer includes stretching the composite layer simultaneously along a first direction and a second direction that is perpendicular to the first direction.

In one embodiment, the operation of biaxially stretching the composite layer includes stretching the composite layer along a first direction, and sequentially stretching the composite layer along a second direction that is perpendicular to the first direction.

In one embodiment, a stretching ratio of the biaxially stretching ranges from 2 to 5.

In yet another aspect of the present invention is to provide a graphene composite film having a crosslinked poly(vinyl alcohol)-graphene mixture layer and a polyester substrate. The crosslinked poly(vinyl alcohol)-graphene mixture layer includes a crosslinked poly(vinyl alcohol) and graphene flake powder dispersed in the crosslinked poly(vinyl alcohol). The polyester substrate is in contact with the crosslinked poly(vinyl alcohol)-graphene mixture layer.

In one embodiment, the graphene flake powder has a weight percentage ranged from 0.1 wt % to 25 wt % in the crosslinked poly(vinyl alcohol)-graphene mixture layer.

In one embodiment, the polyester substrate includes polyethylene terephthalate (PET).

In one embodiment, a thickness ratio of the crosslinked poly(vinyl alcohol)-graphene mixture layer to the polyester substrate ranges from 1:19 to 1:2.

### BRIEF DESCRIPTION OF THE DRAWINGS

The invention can be more fully understood by reading the following detailed description of the embodiment, with reference made to the accompanying drawings as follows.

FIG. 1 is a flow chart of a manufacturing method of a graphene composite film according to some embodiments of the present invention.

FIG. 2 is a schematic view of forming a composite layer by a co-extruding process, according to some embodiments of the present invention.

FIG. 3 is a side view of the graphene composite film according to some embodiments of the present invention.

FIG. 4 is a side view of another graphene composite film according to some embodiments of the present invention.

FIG. 5 is a flow chart of a manufacturing method of a graphene composite film according to some other embodiments of the present invention.

FIG. 6 is a side view of a graphene composite film according to some other embodiments of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations.

These and other features, aspects, and advantages of the present invention will become better understood with reference to the following description and appended claims. It is understood that both the foregoing general description and the following detailed description are by examples, and are intended to provide further explanation of the invention as claimed.

Although below using a series of actions or steps described in the method disclosed, but the order of these actions or steps shown should not be construed to limit the present invention. For example, certain actions or steps may be performed in different orders and/or concurrently with other steps. Moreover, not all steps must be performed in order to achieve the depicted embodiment of the present invention. Furthermore, each operation or procedure described herein may contain several sub-steps or actions.

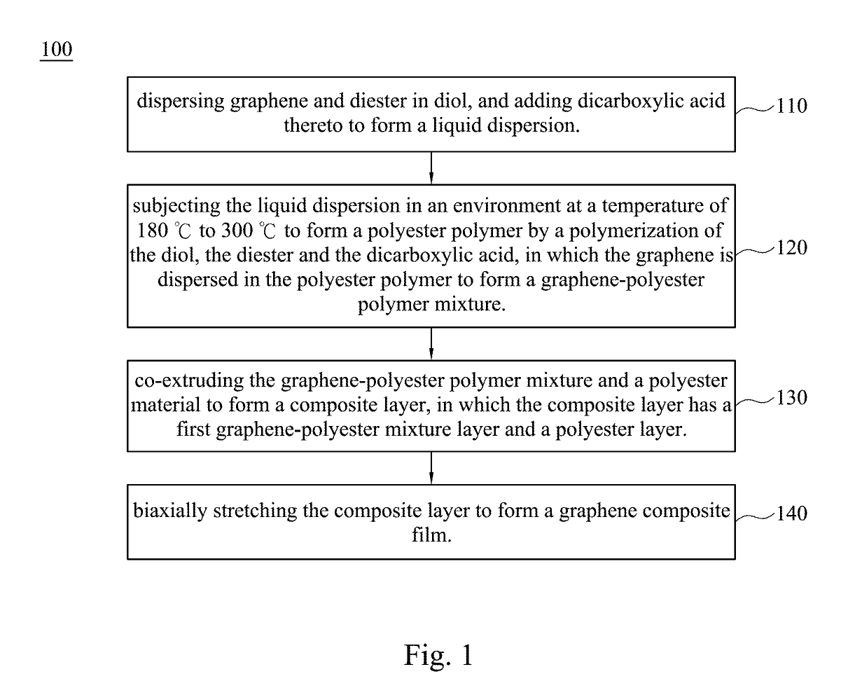

One aspect of the present invention is to provide a manufacturing method of graphene composite film. Referring to FIG. 1, which is a flow chart of a manufacturing method 100 of a graphene composite film according to some embodiments of the present invention. The method 100 includes operation 110, operation 120, operation 130, and operation 140.

In operation 110, graphene and diester are dispersed in diol, and dicarboxylic acid is added therein to form a liquid dispersion.

In some embodiments, the graphene is formed by a pretreatment process as follows. First, spherical graphite and a solid alkali metal are mixed and heated in an inert gas atmosphere such that the alkali metal atom or the alkali metal ion are intercalated between the structural layers of the spherical graphite so to form a graphite intercalation compound. The alkali metal may be lithium, sodium, potassium, or a combination thereof. The molar ratio of the spherical graphite to the alkali metal is 1:8, for example. The heating temperature may be 150° C. to 250° C., and more preferably is 180° C. to 220° C., for example. In one embodiment, the alkali metal is potassium. The inert gas may be such as argon, helium, nitrogen, or the like.

After forming the graphite intercalation compound, the graphite intercalation compound is admixed with an aromatic nitrile compound such that the graphite intercalation compound is reacted with the aromatic nitrile compound, thereby converting the graphite intercalation compound into graphene. Specifically, the aromatic nitrile compound may be combined (or reacted) with the alkali metal intercalated between the structural layers of the graphite intercalation compound, thereby allowing the alkali metal to exit the graphite intercalation compound, and the graphite intercalation compound is peeled off to form graphene. The aromatic nitrile compound may be, for example, benzonitrile. In one embodiment, the mixing of the graphite intercalation compound with the aromatic nitrile compound includes using ultrasonic oscillation to promote uniform mixing of the graphite intercalation compound with the aromatic nitrile compound.

In one embodiment, the diol is ethylene glycol, 1,3-propanediol, 1,4-butanediol, or a combination thereof, for example.

The diester may be a sulfo group-containing diester, for example. In one embodiment, the diester is sodium ethylene glycol isophthalate-5-sulfonate (Sodium Ethylene Glycol Isophthalate-5-sulfonate). The chemical formula of sodium ethylene glycol isophthalate-5-sulfonate is shown below:

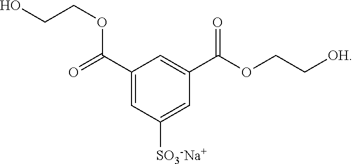

Sodium ethylene glycol isophthalate-5-sulfonate can dissolve in polar solvent such as diol due to the high ionicity of the sulfo group in the sodium ethylene glycol isophthalate-5-sulfonate. The degree of dispersion of the graphene in the diol may be enhanced by adding sodium ethylene glycol isophthalate-5-sulfonate to the diol. In one embodiment, the weight ratio of the graphene to the sodium ethylene glycol isophthalate-5-sulfonate is about 1:1.

In one embodiment, the dicarboxylic acid may be terephthalic acid or similar acid, for example. In one embodiment, the manufacturing method further includes adding catalyst into the liquid dispersion. The catalyst may be antimony trioxide (Sb₂O₃), titanium butoxide (Ti(Obu)₄) and/or similar catalyst thereof, for example.

In operation 120, the liquid dispersion is subjected in an environment at a temperature of 180° C. to 300° C. such that the diol, the diester and the dicarboxylic acid are polymerized to form a polyester polymer, in which the graphene is dispersed in the polyester polymer, thereby forming a graphene-polyester polymer mixture. Specifically, the formation of the polyester polymer includes an esterification reaction of the diol with the dicarboxylic acid, and a polymerization reaction of the product of the esterification reaction with the diester. In one embodiment, based on the total weight of the graphene-polyester polymer mixture, the weight percentage of the graphene ranges from 0.1 wt % to 10 wt %, more preferably 0.5 wt % to 5 wt %, such as 1 wt %, 2 wt %, 3 wt % or 4 wt %. If the weight percentage of the graphene is greater than a certain level, for example, 10 wt %, the film-forming ability and the transmittance of the resulting graphene composite film will decrease. If the weight percentage of the graphene is lower than a certain level, for example, 0.1 wt %, the conductivity of the resulting graphene composite film will decrease.

In operation 130, the graphene-polyester polymer mixture and polyester material are co-extruded to form a composite layer. The composite layer includes a first graphene-polyester mixture layer and a polyester layer.

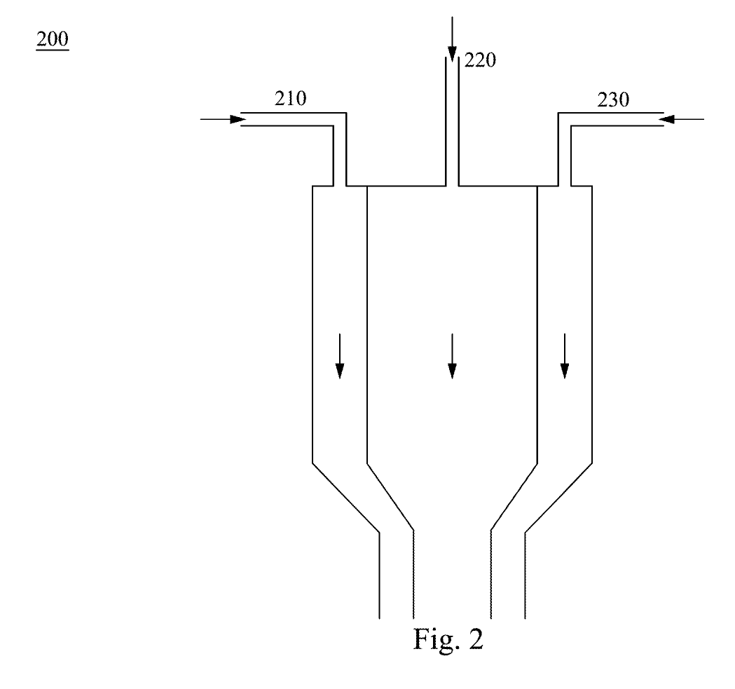

Referring to FIG. 1 and FIG. 2, FIG. 2 is a schematic drawing illustrating forming an approach of co-extruding the graphene-polyester polymer mixture and the polyester material to form the composite layer, according to some embodiments. In FIG. 2, an extrusion die 200 of a twin screw extruder is illustrated. The extrusion die 200 includes a first inlet port 210, a second inlet port 220, and a third inlet port 230.

In one embodiment, the graphene-polyester polymer mixture is injected into the first inlet port 210, and the polyester material is injected into the second inlet port 220. Next, the graphene-polyester polymer mixture and the polyester material are co-extruded. A composite layer having the first graphene-polyester mixture layer and the polyester layer is formed after the co-extruding process. In the co-extruding process, the output volume ratio of the graphene-polyester polymer mixture to the polyester material may be 1:5 to 1:15 (graphene-polyester polymer mixture: polyester material), such as 1:7, 1:9, or 1:11. The temperature of the co-extruding process may be about 270° C. to 280° C., for example.

In one embodiment, the polyester material includes polyethylene terephthalate (PET). In one embodiment, the thickness ratio of the first graphene-polyester mixture layer to the polyester layer is about 1:19 to 1:2 (first graphene-polyester mixture layer: polyester layer), such as 1:15, 1:10, 1:8, 1:5, or 1:3. If the thickness of the polyester layer is too high, the conductivity of the resulting graphene composite film will decrease significantly. If the thickness of the polyester layer is too low, the manufacturing cost of resulting graphene composite film will increase significantly. In one embodiment, the thickness of the composite layer is 40 μm to 200 μm, more preferably is 60 μm to 100 μm, such as 80 μm. In one embodiment, the thickness of the first graphene-polyester mixture layer is 4 μm to 26 μm, more preferably is 8 μm to 24 μm, such as 16 μm.

In another embodiment, the graphene-polyester polymer mixture is injected into the first inlet port 210, the polyester material is injected into the second inlet port 220, and the graphene-polyester polymer mixture is injected into the third inlet port 230. Thereafter, a co-extruding process is performed.

The composite layer formed by the co-extruding process further includes a second graphene-polyester polymer mixture layer according to another embodiment. The polyester layer is between the first graphene-polyester mixture layer and the second graphene-polyester polymer mixture layer. In one embodiment, the second graphene-polyester polymer mixture layer has the same material composition with the first graphene-polyester mixture layer. In one embodiment, a thickness ratio of the second graphene-polyester polymer mixture layer to the polyester layer is 1:19 to 1:2 (second graphene-polyester polymer mixture layer: polyester layer), such as 1:15, 1:10, 1:8, 1:5, or 1:3. If the thickness of the polyester layer is too high, the conductivity of the resulting graphene composite film will decrease significantly. If the thickness of the polyester layer is too low, the manufacturing cost of the graphene composite film will increase significantly.

The composite layer formed by the co-extruding process is electrically conductive since the composite layer has conductive graphene. In addition, since the composite layer formed after the co-extruding process has a low-cost polyester layer, the production cost of the composite layer and the addition amount of the graphene in the composite layer may be reduced. Moreover, the first graphene-polyester mixture layer, the polyester layer, and the second graphene-polyester polymer mixture layer in the composite layer cooperates together to enhance the stretching properties of the composite layer, which ease the further processing of the composite layer.

In operation 140, the composite layer formed by the co-extruding process is biaxially stretched to form a graphene composite film. In one embodiment, the biaxially stretching includes stretching the composite layer simultaneously along a first direction and a second direction that is perpendicular to the first direction. In another embodiment, the biaxially stretching includes stretching the composite layer along a first direction first and then stretching the composite layer in a second direction that is perpendicular to the first direction. The biaxially stretching enables the graphene composite film to have a larger area and a thinner thickness, as compared with the composite layer formed by the co-extruding process.

In one embodiment, the stretch ratio (in one dimension, e.g., length or width) of the biaxially stretching is 2 to 5, preferably 3.3 to 4. If the stretch ratio of the biaxially stretching is greater than a certain level, for example, 5, the resulting graphene composite film may prone to be torn. If the stretch ratio of the biaxially stretching is smaller than a certain level, for example, 2, the reduction of the thickness and the increase of area of the resulting graphene composite film will be limited.

In one embodiment, the preheat temperature in the biaxially stretching process is 90° C. to 120° C., such as 95° C., 100° C., 105° C., 110° C., or 115° C. In one embodiment, the preheat time of the biaxially stretching process is 3 seconds to 20 seconds, such as 4.5 seconds, 7.5 seconds, 9 seconds, or 15 seconds. In one embodiment, a stretch rate (in one dimension, e.g., length or width) of the biaxially stretching ranges from 40%/second to 150%/second such as 60%/second, 80%/second, 100%/second or 134%/second. For example, a stretch rate of 100%/sec refers to that the stretched length has an increase of 1 fold of the original length per second in one stretching direction (i.e., a stretch ratio of 2). In one embodiment, the graphene composite film formed by the biaxially stretching has a thickness of 2 μm to 8 μm, more preferably is 4 μm to 6 μm, such as 5 μm. In one embodiment, the first graphene-polyester mixture layer has a thickness of 100 nm to 6000 nm, more preferably is 400 nm to 600 nm, such as 500 nm.

It is noted that the graphene composite film obtained by the manufacturing method of the present invention has graphene dispersed in the polyester polymer. Therefore, the graphene composite film has high conductivity due to the high conductivity of the graphene, besides of the advantages of smaller thickness and larger area.

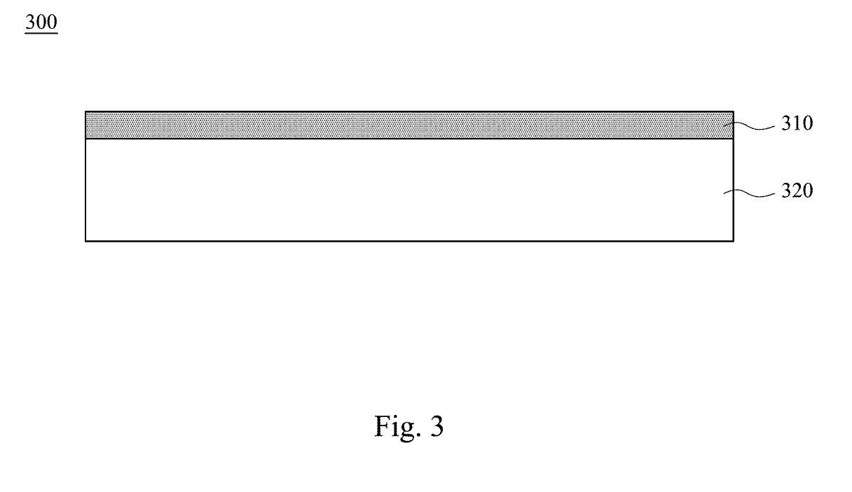

Another aspect of the present invention is to provide a graphene composite film. FIG. 3 is a side view of the graphene composite film 300 according to some embodiments of the present invention. The graphene composite film 300 includes a first graphene-polyester mixture layer 310 and a polyester layer 320. The first graphene-polyester mixture layer 310 includes a plurality of graphene particles and polyester. The graphene particles are dispersed in the polyester. The polyester layer 320 is in contact with the first graphene-polyester mixture layer 310.

In one embodiment, the weight percentage of the graphene particles in the first graphene-polyester mixture layer 310 is 0.1 wt % to 10 wt %, more preferably 0.5 wt % to 5 wt %, such as 1 wt %, 2 wt %, 3 wt %, or 4 wt %. If the weight percentage of the graphene particles is greater than a certain level such as for example 10 wt %, the film-forming ability and the transmittance of the graphene composite film 300 will be poor. If the weight percentage of the graphene particles is lower than a certain level such as for example 0.1 wt %, the conductivity of the graphene composite film 300 will decrease.

In one embodiment, the polyester layer 320 includes polyethylene terephthalate (PET). In one embodiment, a thickness ratio of the first graphene-polyester mixture layer 310 to the polyester layer 320 is 1:19 to 1:2, such as 1:15, 1:10, 1:8, 1:5, or 1:3. If the thickness of the polyester layer 320 is too high, the conductivity of the graphene composite film 300 will decrease significantly. If the thickness of the polyester layer 320 is too low, the manufacturing cost of the graphene composite film 300 will increase significantly. In one embodiment, the thickness of the graphene composite film 300 is 2 μm to 18 μm, preferably 4 μm to 6 μm, such as 5 μm. In one embodiment, the thickness of the first graphene-polyester mixture layer is 100 nm to 6000 nm, preferably 400 nm to 600 nm, such as 500 nm.

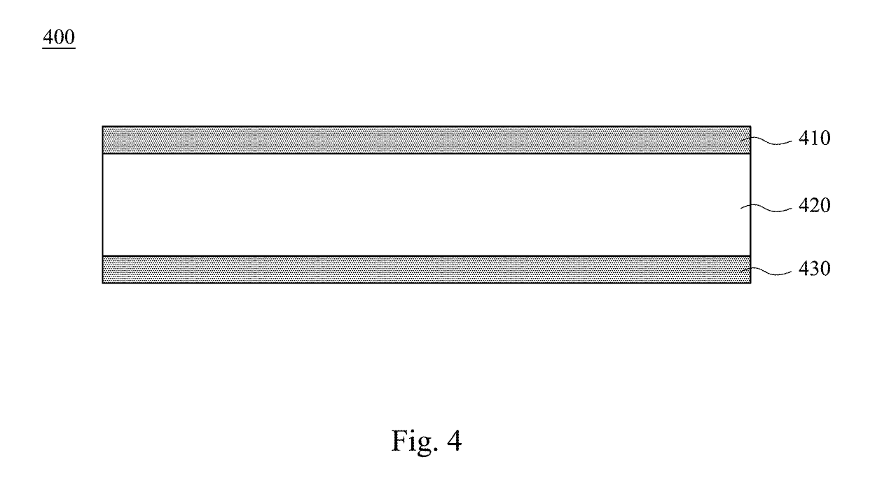

FIG. 4 is a side view of another graphene composite film 400 according to some embodiments of the present invention. The graphene composite film 400 includes a first graphene-polyester mixture layer 410, a polyester layer 420, and a second graphene-polyester polymer mixture layer 430. The first graphene-polyester mixture layer 410 and the second graphene-polyester polymer mixture layer 430 include a plurality of graphene particles and polyester. The graphene particles are dispersed in the polyester. The polyester layer 420 is between the first graphene-polyester mixture layer 410 and the second graphene-polyester polymer mixture layer 430. In one embodiment, the first graphene-polyester mixture layer 410 has the same material composition as the second graphene-polyester polymer mixture layer 430. In one embodiment, the weight percentage of the graphene in the first graphene-polyester mixture layer 410 or the second graphene-polyester polymer mixture layer 430 is 0.1 wt % to 10 wt %, preferably 0.5 wt % to 5 wt %, such as 1 wt %, 2 wt %, 3 wt % or 4 wt %. In one embodiment, the thickness ratio of the first graphene-polyester mixture layer 410 and/or the second graphene-polyester polymer mixture layer 430 each to the polyester layer 420 is 1:19 to 1:2, such as 1:15, 1:10, 1:8, 1:5, or 1:3. In one embodiment, the thickness of the graphene composite film 400 is 2 μm to 18 μm, preferably 4 μm to 6 μm, such as 5 μm.

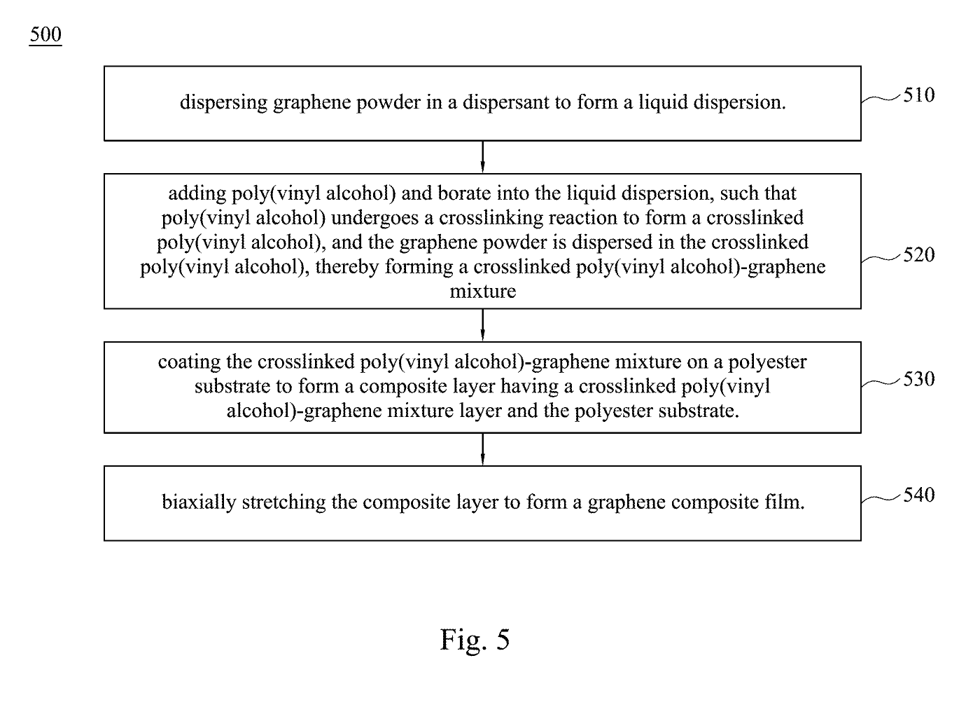

FIG. 5 is a flow chart of a manufacturing method 500 of a graphene composite film according to some other embodiments of the present invention. The method 500 includes operation 510, operation 520, operation 530, and operation 540.

In operation 510, dispersing graphene powder in a dispersant to form a liquid dispersion.

In some embodiments, the graphene powder may be formed by the method described below. First, a spherical graphite and a solid alkali metal are mixed and heated in an inert gas atmosphere such that the alkali metal atom or the alkali metal ion are intercalated between the structural layers of the spherical graphite so as to form a graphite intercalation compound. The alkali metal may be lithium, sodium, potassium, or a combination thereof. The molar ratio of the spherical graphite to the alkali metal is 1:8, for example. The heating temperature may be 150° C. to 250° C., more preferably is 180° C. to 220° C., for example. In one embodiment, the alkali metal is potassium. The inert gas may be such as argon, helium, nitrogen, or the like.

After forming the graphite intercalation compound, the graphite intercalation compound is admixed with an aromatic nitrile compound such that the graphite intercalation compound is reacted with the aromatic nitrile compound, thereby converting the graphite intercalation compound to graphene. Specifically, the aromatic nitrile compound may be combined (or reacted) with the alkali metal intercalated between the structural layers of the graphite intercalation compound. As a result, the alkali metal exits the graphite intercalation compound, and the graphite intercalation compound is peeled off to form graphene. The aromatic nitrile compound may be, for example, benzonitrile. In one embodiment, the mixing of the graphite intercalation compound with the aromatic nitrile compound includes using ultrasonic oscillation to promote uniform mixing of the graphite intercalation compound with the aromatic nitrile compound.

In one embodiment, the dispersant is selected from isopropanol, N-Methyl-2-Pyrrolidone (NMP), water, or a combination thereof. In one embodiment, the weight ratio of isopropanol, NMP and water is 88:2:10. In one embodiment, the manufacturing method further includes applying ultrasonic oscillation to the liquid dispersion for promoting the uniform dispersion of the graphene in the dispersant.

In operation 520, poly(vinyl alcohol) and borate are added into the liquid dispersion such that poly(vinyl alcohol) undergoes a crosslinking reaction to form a crosslinked poly(vinyl alcohol), in which the graphene powder is dispersed in the crosslinked poly(vinyl alcohol), thereby forming a crosslinked poly(vinyl alcohol)-graphene mixture. In one embodiment, the poly(vinyl alcohol) and the borate are added into the liquid dispersion sequentially. In one embodiment, the operation 520 includes forming the crosslinked poly(vinyl alcohol)-graphene mixture at a temperature of about 90° C. to 110° C. In one embodiment, the operation 520 includes forming the crosslinked poly(vinyl alcohol)-graphene mixture at a pressure of about 300 kPa to 1000 kPa.

Specifically, hydrogen bonds are formed between the borate and the poly(vinyl alcohol), and water molecules are produced, thereby forming the crosslinked poly(vinyl alcohol). In one embodiment, the borate includes sodium tetraborate or similar material thereof. In one embodiment, the weight percentage of the graphene powder in the crosslinked poly(vinyl alcohol)-graphene mixture is 0.1 wt % to 25 wt %, preferably is 0.5 wt % to 20 wt %, such as 1 wt %, 5 wt %, 10 wt %, or 15 wt %. If the weight percentage of the graphene powder is greater than a certain level, for example, 25 wt %, the film-forming ability and the transmittance of the resulting graphene composite film will decrease. If the weight percentage of the graphene powder is lower than a certain level, for example, 0.1 wt %, the conductivity of the resulting graphene composite film will decrease.

In operation 530, the crosslinked poly(vinyl alcohol)-graphene mixture is coated on the polyester substrate to form a composite layer. The obtained composite layer includes a layer of the crosslinked poly(vinyl alcohol)-graphene mixture and a polyester substrate. In one embodiment, the polyester substrate includes polyethylene terephthalate (PET). In one embodiment, in the composite layer, the thickness of the dried crosslinked poly(vinyl alcohol)-graphene mixture layer is 100 nm to 1000 nm, preferably 200 nm to 400 nm, such as about 300 nm. In one embodiment, the crosslinked poly(vinyl alcohol)-graphene mixture may be coated on the polyester substrate by techniques known in the art, such as micro-gravure coating, slot-die coating, but not limited thereto. In one embodiment, a thickness ratio of the dried crosslinked poly(vinyl alcohol)-graphene mixture layer to the polyester substrate is 1:19 to 1:2 (crosslinked poly(vinyl alcohol)-graphene mixture layer: polyester substrate), such as 1:15, 1:10, 1:8, 1:5, or 1:3.

In operation 540, the composite layer is biaxially stretched to form a graphene composite film. In one embodiment, the biaxially stretching includes stretching the composite layer simultaneously along a first direction and a second direction that is perpendicular to the first direction. In one embodiment, the biaxially stretching includes stretching the composite layer along a first direction firstly and then stretching the composite layer along a second direction that is perpendicular to the first direction sequentially. The biaxially stretching enables the graphene composite film to have a larger area and a thinner thickness, as compared with the composite layer.

In one embodiment, a stretch ratio of the biaxially stretching is 2 to 5, preferably 3.3 to 4.0. If the stretch ratio of the biaxially stretching is greater than a certain level, for example, 5, the resulting graphene composite film may prone to be torn. If the stretch ratio of the biaxially stretching is smaller than a certain level, for example, 2, the reduction of the thickness and the expansion of the area of the resulting graphene composite film will be limited.

In one embodiment, the preheat temperature in the biaxially stretching process is 90° C. to 120° C., such as 95° C., 100° C., 105° C., 110° C., or 115° C. In one embodiment, the preheat time of the biaxially stretching is 3 seconds to 20 seconds, such as 4.5 seconds, 7.5 seconds, 9 seconds or 15 seconds. In one embodiment, a stretch rate of the biaxially stretching ranges from 40%/second to 150%/second, such as 60%/second, 80%/second, 100%/second, or 134%/second. For example, when the stretch rate is 100%/sec, the stretched length has an increase of 1 fold of the original length (i.e., stretch ratio is 2) per second in one stretching direction. In one embodiment, the graphene composite film formed by the biaxially stretching has a thickness of 2 μm to 18 μm, more preferably is 4 μm to 6 μm. In one embodiment, the thickness of the crosslinked poly(vinyl alcohol)-graphene mixture layer after the biaxially stretching is 6 nm to 100 nm, preferably 10 nm to 30 nm, such as about 20 nm.

It is noted that the graphene composite film obtained by the manufacturing method of the present invention has graphene dispersed in the polyester polymer. Therefore, the graphene composite film has high conductivity due to the high conductivity of the graphene, besides of the advantages of smaller thickness and larger area.

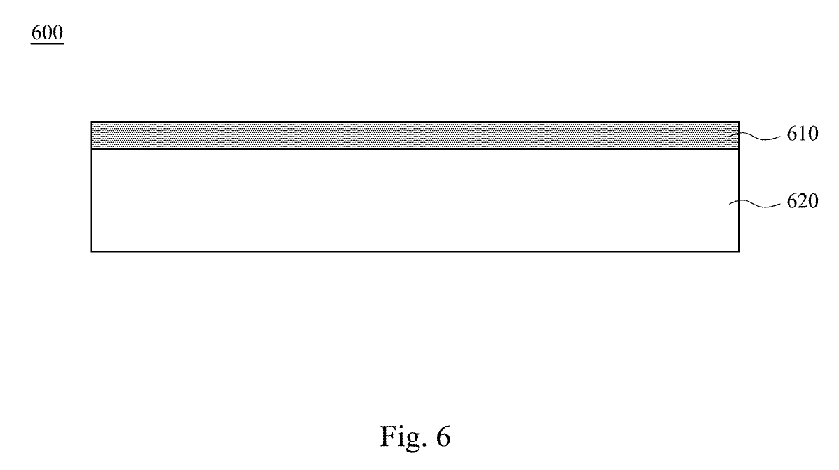

Another aspect of the present invention provides a graphene composite film. FIG. 6 is a side view of a graphene composite film 600 according to some other embodiments of the present invention. The graphene composite film 600 includes a crosslinked poly(vinyl alcohol)-graphene mixture layer 610 and a polyester substrate 620. The crosslinked poly(vinyl alcohol)-graphene mixture layer 610 includes graphene flake powder and crosslinked poly(vinyl alcohol), and the graphene flake powder is dispersed in the crosslinked poly(vinyl alcohol). The crosslinked poly(vinyl alcohol)-graphene mixture layer 610 is in contact with the polyester substrate 620, and is disposed on the polyester substrate 620.

In one embodiment, the weight percentage of the graphene flake powder in the crosslinked poly(vinyl alcohol)-graphene mixture layer 610 is 0.1 wt % to 25 wt %, preferably 0.5 wt % to 20 wt %, such as 1 wt %, 5 wt %, 10 wt %, or 15 wt %. If the weight percentage of the graphene flake powder is greater than 25 wt %, the film-forming ability and the transmittance of the graphene composite film 600 will be poor. If the weight percentage of the graphene flake powder is lower than 0.1 wt %, the conductivity of the graphene composite film 600 will decrease.

In one embodiment, the polyester substrate 620 is polyethylene terephthalate (PET). In one embodiment, the thickness of the dried crosslinked poly(vinyl alcohol)-graphene mixture layer 610 is 6-100 nm, preferably 10-30 nm, such as about 20 nm. In one embodiment, the graphene composite film 600 has a thickness of 2 μm to 18 μm, preferably 4 μm to 6 μm. In one embodiment, the thickness ratio of the dried crosslinked poly(vinyl alcohol)-graphene mixture layer 610 to the polyester substrate 620 is 1:19 to 1:2 (crosslinked poly(vinyl alcohol)-graphene mixture layer 610: polyester substrate 620), such as 1:15, 1:10, 1:8, 1:5, or 1:3.

The following examples are intended to describe some specific aspects of the invention and to enable those skilled in the art to which the invention pertains to practice the invention. However, the following examples do not intended to limit the present invention.

Example 1 and Example 2 describe different manufacturing methods of graphene composite film. For clarity, in the following description, the graphene composite films prepared in Example 1 and Example 2, the weight percentage of graphene in the graphene-polyester mixture layer or the crosslinked poly(vinyl alcohol)-graphene mixture layer will be referred to as graphene content for short, which is in unit of wt %.

### Example 1

### Preparation of Composite Layer (1-A) and Graphene Composite Film (1-A)

In an environment of argon, 480 mg of spherical graphite powder and 195 mg of potassium were mixed in a glass bottle, and the glass bottle was evacuated and sealed. The glass bottle was then heated to 200° C., and cooled to room temperature for three days to form graphite intercalation compound powder. In the presence of argon, the graphite intercalation compound powder in the glass bottle was taken out and added into 4.5 L of benzonitrile, followed by an ultrasonic treatment for 5 minutes. At this time, it was observed that the appearance of the benzonitrile solution turned red. Next, water was slowly added dropwise to the benzonitrile solution until the appearance of the benzonitrile solution changed from red to colorless. Black suspension particles suspended in benzonitrile solution were observed at this time. The black suspension particles in benzonitrile solution were then filtered and dried at 70° C. The dried black powder was graphene.

Next, the obtained graphene is used to form a graphene-polyester polymer mixture, with details provided below. At room temperature, 2.47 g of graphene and sodium ethylene glycol isophthalate-5-sulfonate in equal weight (graphene content of 1%) were added to 80.7 g of ethylene glycol, stirred vigorously and ultrasonically oscillated for 1 hour to form a liquid dispersion. 166.1 g of terephthalic acid, 1 g of Sb₂O₃ and 1 g of Ti(Obu)₄ were then added to the liquid dispersion, and the liquid dispersion was stirred for 1 hour under a nitrogen atmosphere at a temperature of 200° C. Next, the temperature was increased to 240° C. and the stirring was continued for 4 hours to carry out the esterification reaction of ethylene glycol and terephthalic acid. The water produced by the esterification reaction was collected. When the amount of water collected was greater than 95% of the theoretical value and the appearance of the product was clear, the esterification reaction of ethylene glycol and terephthalic acid is deemed completed. The temperature was then increased to a range of 275° C. to 285° C. and a vacuum was applied so that the product of the esterification reaction was further polymerized with sodium ethylene glycol isophthalate-5-sulfonate to form a graphene-polyester polymer mixture. The duration of the polymerization was 2 hours to 3 hours. After the polymerization reaction was completed, the graphene-polyester polymer mixture was extruded and pelletized.

The pellets of the graphene-polyester polymer mixture were fed into a first inlet port of a twin screw extruder, and pellets of polyethylene terephthalate (PET) were fed into a second inlet port of the twin screw extruder, and co-extruded to form Composite layer (1-A). The Composite layer (1-A) has a graphene-polyester polymer mixture layer and a polyester layer. The feed ratio of the first inlet port and the second inlet port was 1:9, and the temperature of the twin-screw extruder was 275° C. The Composite layer (1-A) formed by the co-extruding process has a thickness of 80 μm.

After forming the Composite layer (1-A) by the co-extruding process, the Composite layer (1-A) was stretched, simultaneously along two directions perpendicular to each other, under conditions of a preheat temperature of 105° C., a preheating time of 4.5 seconds, a stretch rate of 134%/second and a stretch ratio of 3.8 times. A graphene composite film (1-A) was then obtained. The graphene composite film (1-A) has a transparent appearance with a thickness of 5±1 μm, which includes a graphene-polyester polymer mixture layer having a thickness of about 0.5 μm.

### Preparation of Composite Layer (1-B) and Graphene Composite Film (1-B)

The manufacturing method of the Composite layer (1-B) and the graphene composite film (1-B) are substantially the same as the manufacturing method of the Composite layer (1-A) and the graphene composite film (1-A), with the only difference in the graphene content. The graphene content of the Composite layer (1-B) and the graphene composite film (1-B) is 3 wt %.

### Preparation of Composite Layer (1-C) and the Graphene Composite Film (1-C)

The manufacturing method of the Composite layer (1-C) and the graphene composite film (1-C) are substantially the same as the manufacturing method of the Composite layer (1-A) and the graphene composite film (1-A), with the only difference in the graphene content. The graphene content of the Composite layer (1-C) and the graphene composite film (1-C) is 10 wt %.

In order to understand whether biaxial stretching will cause a change in properties of the resulting graphene composite film, the properties of the biaxially-stretched graphene composite film (1-A), graphene composite film (1-B), and the graphene composite films (1-C) were compared with those of Composite layer (1-A), Composite layer (1-B) and Composite layer (1-C), respectively, which had not subjected to biaxially-stretching.

The properties include electrical conductivity (S/m), sheet resistance (Ω/square), thickness of the graphene-polyester mixture layers (μm) before and after stretching, and transmittance at a wavelength of 550 nm (hereinafter referred to as the transmittance T₅₅₀, in unit of %). The results of the properties comparison are listed in Table 1.

TABLE 1

| | | | thickness of the | | | |
|---|---|---|---|---|---|---|
| | | graphene | graphene-polyester | electrical | sheet | transmittance |
| | | content | mixture layer | conductivity | resistance | T₅₅₀ |
| | | (wt %) | (μm) | (S/m) | (Ω/square ) | (%) |
| graphene | (1-A) | 1 | 0.5 | 85 | 23500 | 90 |
| composite | (1-B) | 3 | 0.5 | 3900 | 513 | 70 |
| film | (1-C) | 10 | 0.5 | 110000 | 43 | — |
| (after | | | | | | |
| biaxial | | | | | | |
| stretching) | | | | | | |
| composite | (1-A) | 1 | 7.2 | 20 | 6900 | 30 |
| layer | (1-B) | 3 | 7.2 | 1100 | 126 | — |
| (before | (1-C) | 10 | 7.2 | 32000 | 18 | — |
| biaxial | | | | | | |
| stretching) | | | | | | |

According to the data in Table 1, it can be seen that after the biaxial stretching, the thickness of each graphene-polyester mixture layer (after stretching) of the graphene composite film (1-A), graphene composite film (1-B) and graphene composite film (1-C) has reduced to 0.5 μm, which are approximately 0.07 times of the graphene-polyester mixture layers (before stretching) of the Composite layer (1-A), Composite layer (1-B) and Composite layer (1-C), respectively. The high ductility may be contributed from the polyester layer existed in Composite layer (1-A), Composite layer (1-B), and Composite layer (1-C). That is, the base polyester layer may significantly increase the ductility of the composite layer. Therefore, after the biaxially-stretching, the composite layer may be formed into the graphene composite film with a small thickness and can be produced in a large-scale production.

In addition, the electrical conductivity of graphene composite film (1-A), graphene composite film (1-B) and graphene composite film (1-C) are increased to about 4.3 times, 3.5 times and 3.4 times of the Composite layer (1-A), Composite layer (1-B) and Composite layer (1-C), respectively. The electrical conductivity of the graphene composite film (1-C) is up to 110,000 S/m. It is possible that the biaxial stretching promotes the alignment of the polyester in the composite layer, which in turn enhance the alignment of the graphene dispersed in the polyester, thereby increasing the electrical conductivity of the graphene composite film, resulting to the high electrical conductivity of each of the graphene composite film (1-A), graphene composite film (1-B) and graphene composite film (1-C).

Furthermore, the transmittance of the graphene composite film (1-A) is as high as 90%, which is about 3 times than that of Composite layer (1-A). This may be because the light can more easily transmit through thinner graphene composite film. Therefore, the graphene composite film can be widely used in the field of optical film.

### Example 2

The preparation method of the graphene composite film provided by Example 2 is different from Example 1. The specific details are provided as follow.

### Preparation of Composite Layer (2) and Graphene Composite Film (2)

1 g of graphene was added to 100 mL of a mixed solution and ultrasonic oscillated for 1 hour. Graphene was prepared in the same manner as in Example 1 and will not be repeated herein. The mixed solution was prepared by mixing isopropanol, NMP and water in a weight ratio of 88:2:10. Next, 4 g of poly(vinyl alcohol) was added to the mixed solution. The poly(vinyl alcohol) was dispersed in the mixed solution at a pressure of 300-1000 kPa and a temperature of 100° C. using a homogenizer with a rotation speed of 4000 rpm for a dispersion time of 1 hour. 1 g of sodium tetraborate was dissolved in 100 mL of deionized water, and the obtained sodium tetraborate aqueous solution was added to the mixed solution containing the poly(vinyl alcohol) dispersed therein. Then, the whole mixture was stirred for 20 minutes such that poly(vinyl alcohol) was cross-linked to form crosslinked poly(vinyl alcohol), in which the graphene powder was dispersed in the crosslinked poly(vinyl alcohol), so as to form the crosslinked poly(vinyl alcohol)-graphene mixture.

After forming the crosslinked poly(vinyl alcohol)-graphene mixture, the crosslinked poly(vinyl alcohol)-graphene mixture is coated on a PET substrate by a slit coating process, and the coated crosslinked poly(vinyl alcohol)-graphene mixture layer was dried in an oven at 100° C. The dried crosslinked poly(vinyl alcohol)-graphene mixture layer has a thickness of 0.3 μm. the PET substrate and the overlying crosslinked poly(vinyl alcohol)-graphene mixture layer together are termed as Composite layer (2).

After forming the Composite layer (2) by the coating process, the Composite layer (2) was stretched simultaneously in two directions perpendicular to each other so as to form the graphene composite film (2). The stretching process was carried out with process conditions of a preheat temperature of 105° C., a preheating time of 4.5 seconds, a stretch rate of 134%/second and a stretch ratio of 3.8 times. The stretched graphene composite film (2) has a transparent appearance and a thickness of 4.5 μm. The graphene composite film (2) has a crosslinked poly(vinyl alcohol)-graphene mixture layer with a thickness of about 0.02 μm. The graphene content in the graphene composite film was 16.6 wt %.

In order to understand whether the biaxial stretching would cause a change in the properties of the resulting graphene composite film, the properties of the graphene composite film (2) subjected to biaxially stretching and the Composite layer (2) without biaxially stretching were compared.

The properties include electrical conductivity (S/m), sheet resistance (Ω/square), the thickness of the crosslinked poly(vinyl alcohol)-graphene mixture layer (in μm), and transmittance at a wavelength of 550 nm (hereinafter referred to as transmittance T₅₅₀, in unit of %). The results are listed in Table 2.

TABLE 2

| | | thickness of | | | |
|---|---|---|---|---|---|
| | | the graphene - | | sheet | |
| | | crosslinked | electrical | resis- | transmit- |
| | graphene | poly(vinyl | conduc- | tance | tance |
| | content | alcohol) | tivity | (Ω/ | T₅₅₀ |
| | (wt %) | (μm) | (S/m) | square) | (%) |
| graphene | 16.6 | 0.02 | 274000 | 730 | 85 |
| composite | | | | | |
| film (2) | | | | | |
| (after | | | | | |
| biaxial | | | | | |
| stretching) | | | | | |
| Composite | 16.6 | 0.3 | 220000 | 65 | — |
| layer (2) | | | | | |
| (before | | | | | |
| biaxial | | | | | |
| stretching) | | | | | |

As shown in Table 2, after the biaxial stretching, the thickness of the crosslinked poly(vinyl alcohol)-graphene mixture layer in the graphene composite film (2) is 0.02 μm, which is only about 0.07 times of the original thickness in the Composite layer (2). The electrical conductivity of the graphene composite film (2) has increased to about 1.25 times of the Composite layer (2). This may be because of the biaxial stretching which may promote the alignment of the polyester in the composite layer and enhance the alignment of the graphene dispersed in the polyester, thereby increasing the electrical conductivity of the graphene composite film.

Furthermore, the transmittance of the graphene composite film (2) is about 85%, so the graphene composite film can be widely used in the field of transparent conductive films.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A manufacturing method of graphene composite film, comprising operations of:
dispersing graphene and diester in diol and adding dicarboxylic acid thereto to form a liquid dispersion;
subjecting the liquid dispersion in an environment at a temperature of 180° C. to 300° C. to form a polyester polymer by a polymerization of the diol, the diester and the dicarboxylic acid, wherein the graphene is dispersed in the polyester polymer to form a graphene-polyester polymer mixture;
co-extruding the graphene-polyester polymer mixture and a polyester material to form a composite layer, wherein the composite layer comprises a first graphene-polyester mixture layer and a polyester layer; and
biaxially stretching the composite layer to form a graphene composite film.

2. The manufacturing method of claim 1, further comprising performing a pretreatment process to form the graphene prior to the operation of dispersing the graphene and the diester in the diol, wherein the pretreatment process comprises:
heating a mixture of a spherical graphite and alkali metal to form a graphite intercalation compound, wherein the alkali metal is intercalated between structural layers of the spherical graphite; and
mixing the graphite intercalation compound with an aromatic nitrile compound, wherein the graphite intercalation compound reacts with the aromatic nitrile compound to form the graphene.

3. The manufacturing method of claim 1, wherein the diol comprises at least one of ethylene glycol, 1,3-propanediol, and 1,4-butanediol.

4. The manufacturing method of claim 1, wherein the diester comprises sodium ethylene glycol isophthalate-5-sulfonate.

5. The manufacturing method of claim 1, wherein the dicarboxylic acid comprises terephthalic acid.

6. The manufacturing method of claim 1, wherein the graphene has a weight percentage ranged from 0.1 wt % to 10 wt %, based on the total weight of the graphene-polyester polymer mixture.

7. The manufacturing method of claim 1, wherein the polyester material comprises polyethylene terephthalate (PET).

8. The manufacturing method of claim 1, wherein a thickness ratio of the first graphene-polyester mixture layer to the polyester layer ranges from 1:19 to 1:2.

9. The manufacturing method of claim 1, wherein the composite layer further comprises a second graphene-polyester polymer mixture layer, and the polyester layer is between the first graphene-polyester mixture layer and the second graphene-polyester polymer mixture layer.

10. The manufacturing method of claim 9, wherein the second graphene-polyester polymer mixture layer and the first graphene-polyester mixture layer comprise a same material composition.

11. The manufacturing method of claim 9, wherein a thickness ratio of the second graphene-polyester polymer mixture layer to the polyester layer ranges from 1:19 to 1:2.

12. The manufacturing method of claim 1, wherein the operation of biaxially stretching the composite layer comprises stretching the composite layer simultaneously along a first direction and a second direction that is perpendicular to the first direction.

13. The manufacturing method of claim 1, wherein the operation of biaxially stretching the composite layer comprises stretching the composite layer along a first direction and sequentially stretching the composite layer along a second direction perpendicular to the first direction.

14. The manufacturing method of claim 1, wherein a stretch ratio of the biaxially stretching ranges from 2 to 5.

15. A graphene composite film, comprising:
a first graphene-polyester mixture layer comprising a plurality of graphene particles and a polyester, wherein the graphene particles are dispersed in the polyester; and
a polyester layer contacting the first graphene-polyester mixture layer.

16. The graphene composite film of claim 15, wherein the graphene particles has a weight percentage of 0.1 wt % to 10 wt % in the first graphene-polyester mixture layer.

17. The graphene composite film of claim 15, wherein the polyester layer comprises polyethylene terephthalate (PET).

18. The graphene composite film of claim 15, wherein a thickness ratio of the first graphene-polyester mixture layer to the polyester layer ranges from 1:19 to 1:2.

19. The graphene composite film of claim 15, further comprising a second graphene-polyester polymer mixture layer, wherein the polyester layer is between the first graphene-polyester mixture layer and the second graphene-polyester polymer mixture layer, and the first graphene-polyester mixture layer and the second graphene-polyester polymer mixture layer comprise a same material composition.

20. The graphene composite film of claim 15, wherein a thickness ratio of the second graphene-polyester polymer mixture layer to the polyester layer ranges from 1:19 to 1:2.

21. A manufacturing method of graphene composite film, comprising operations of:
dispersing graphene powder in a dispersant to form a liquid dispersion;
adding poly(vinyl alcohol) and borate into the liquid dispersion, such that poly(vinyl alcohol) undergoes a crosslinking reaction to form a crosslinked poly(vinyl alcohol), and the graphene powder is dispersed in the crosslinked poly(vinyl alcohol), thereby forming a crosslinked poly(vinyl alcohol)-graphene mixture;
coating the crosslinked poly(vinyl alcohol)-graphene mixture on a polyester substrate to form a composite layer comprising a crosslinked poly(vinyl alcohol)-graphene mixture layer and the polyester substrate; and
biaxially stretching the composite layer to form a graphene composite film.

22. The manufacturing method of claim 21, further comprising performing a pretreatment process to form the graphene powder before the operation of dispersing the graphene powder in the dispersant to form the liquid dispersion, wherein the pretreatment process comprises:
heating a mixture of a spherical graphite and alkali metal to form a graphite intercalation compound, wherein the alkali metal is intercalated between structural layers of the spherical graphite; and
mixing the graphite intercalation compound with an aromatic nitrile compound, wherein the graphite intercalation compound reacts with the aromatic nitrile compound to form the graphene.

23. The manufacturing method of claim 21, wherein the dispersant is selected from the group consisting of isopropanol, N-Methyl-2-Pyrrolidone (NMP), water, and a combination thereof.

24. The manufacturing method of claim 21, wherein the borate comprises sodium tetraborate.

25. The manufacturing method of claim 21, wherein the graphene powder has a weight percentage ranged from 0.1 wt % to 25 wt % in the crosslinked poly(vinyl alcohol)-graphene mixture.

26. The manufacturing method of claim 21, wherein the polyester substrate comprises polyethylene terephthalate (PET).

27. The manufacturing method of claim 21, wherein a thickness ratio of the crosslinked poly(vinyl alcohol)-graphene mixture layer to the polyester substrate ranges from 1:19 to 1:2.

28. The manufacturing method of claim 21, wherein the operation of biaxially stretching the composite layer comprises stretching the composite layer simultaneously along a first direction and a second direction that is perpendicular to the first direction.

29. The manufacturing method of claim 21, wherein the operation of biaxially stretching the composite layer comprises stretching the composite layer along a first direction, and sequentially stretching the composite layer along a second direction that is perpendicular to the first direction.

30. The manufacturing method of claim 21, wherein a stretch ratio of the biaxially stretching ranges from 2 to 5.

31. A graphene composite film, comprising:
a crosslinked poly(vinyl alcohol)-graphene mixture layer comprising a crosslinked poly(vinyl alcohol) and graphene flake powder dispersed in the crosslinked poly(vinyl alcohol); and
a polyester substrate contacting the crosslinked poly(vinyl alcohol)-graphene mixture layer.

32. The graphene composite film of claim 31, wherein the graphene flake powder has a weight percentage of 0.1 wt % to 25 wt % in the crosslinked poly(vinyl alcohol)-graphene mixture layer.

33. The graphene composite film of claim 31, wherein the polyester substrate comprises polyethylene terephthalate (PET).

34. The graphene composite film of claim 31, wherein a thickness ratio of the crosslinked poly(vinyl alcohol)-graphene mixture layer to the polyester substrate ranges from 1:19 to 1:2.
